(19) United States
(12) Patent Application Publication
(10) Pub. No.: US 2024/0412062 A1
(43) Pub. Date: Dec. 12, 2024

(54) LEARNING FROM AND PROVIDING MEMORIES

(71) Applicant: International Business Machines Corporation, Armonk, NY (US)

(72) Inventors: Tathagato Bose, Kolkata (IN); Arun Joseph, Bangalore (IN)

(21) Appl. No.: 18/331,993

(22) Filed: Jun. 9, 2023

(51) Int. Cl. G06N 3/08

(52) U.S. Cl. CPC G06N 3/08

(57) ABSTRACT

According to one embodiment, a method, computer system, and computer program product for providing memories based on a process of machine learning is provided. The embodiment may include collecting biometric data from a subject in response to an event. The embodiment may also include building a graph based on the collected biometric data. The embodiment may further include training a machine learning model based on the built graph. The embodiment may also include providing a memory to a user based on the machine learning model.

### BACKGROUND

The present invention relates generally to the field of computing, and more particularly to human-computer interaction (HCI).

Computers have the potential to dramatically improve human lives. However, the barrier between a user and a computing device can seriously limit that potential. HCI is the field of using computer input and output, neurology, and computation in concert to advance the way computers support human life. In addition to more common methods of input and output, HCI often utilizes input of biometric data such as heart rate data; output through stimuli such as vibration or specific audio signals; and algorithms such as machine learning, natural language processing, and computer vision techniques in order to help computers understand and achieve their tasks, helping users achieve what they previously could not.

### SUMMARY

According to one embodiment, a method, computer system, and computer program product for providing memories based on a process of machine learning is provided. The embodiment may include collecting biometric data from a subject in response to an event. The embodiment may also include building a graph based on the collected biometric data. The embodiment may further include training a machine learning model based on the built graph. The embodiment may also include providing a memory to a user based on the machine learning model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for providing memories to users based on human memory retrieval.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to HCI. The following described exemplary embodiments provide a system, method, and program product to, among other things, provide memories to users based a process of machine learning from past memories. Therefore, the present embodiment has the capacity to improve the technical field of human-computer interface by learning from a pattern of human memories and reactions and providing stimuli to assist users with memories.

As previously described, HCI is the field of using computer input and output, neurology, and computation in concert to advance the way computers support human life. In addition to more common methods of input and output, HCI often utilizes input of biometric data such as heart rate data; output through stimuli such as vibration or specific audio signals; and algorithms such as machine learning, natural language processing, and computer vision techniques in order to help computers understand and achieve their tasks, helping users achieve what they previously could not.

Certain tasks practically require humans to learn and remember skills and patterns over time. However, many humans have little experience with certain important tasks, have imperfect memories, or suffer from memory disorders that make such tasks impractical or impossible. As such, it may be advantageous to, among other things, collect biometric data regarding human-computer interactions, store that data reliably, train a machine learning algorithm to understand patterns in human memories and reactions, and make recommendations to those users.

According to one embodiment, a memory provision program provides recommendations to users based on human memory patterns. The memory provision program may collect biometric data from a subject. The memory-based recommendation may build a graph based on the collected biometric data. The memory provision program may then train a machine learning model based on the graph. The document collaboration program may finally provide memories to users in using the trained machine learning model.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

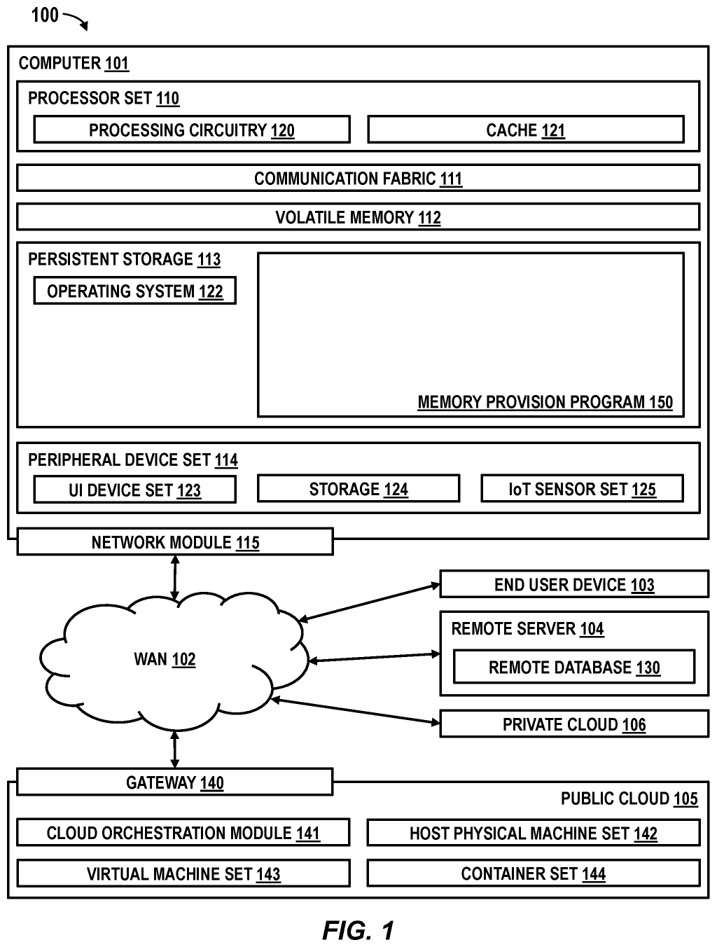

Referring now to FIG. 1, computing environment 100 contains an example of an environment for the execution of at least some of the computer code involved in performing the inventive methods, such as memory provision program 150. In addition to memory provision program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and memory provision program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in memory provision program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and rewriting of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in memory provision program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The memory provision program 150 may collect biometric data from a subject. The memory provision program 150 may then build a graph based on the collected biometric data. Then memory provision program 150 may train a machine learning model based on the graph. memory provision program 150 may then provide memories to users using the trained machine learning model.

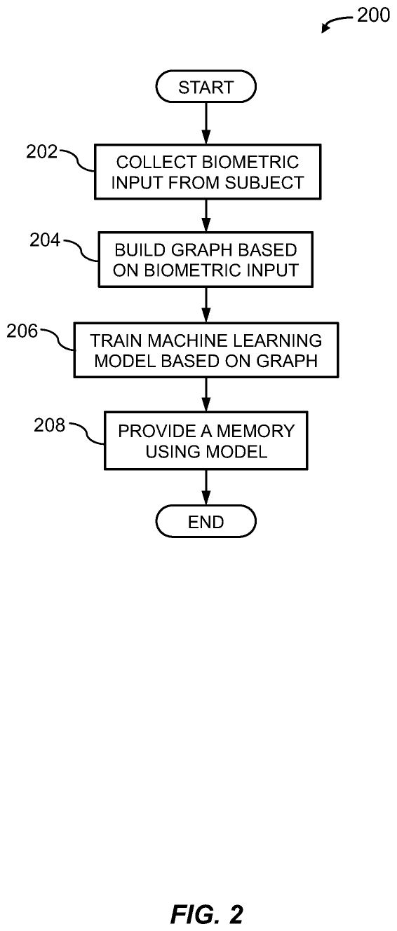

Furthermore, notwithstanding depiction in computer 101, memory provision program 150 may be stored in and/or executed by, individually or in any combination, end user device 103, remote server 104, public cloud 105, and private cloud 106. The memory provisioning method is explained in more detail below with respect to FIG. 2.

Referring now to FIG. 2, an operational flowchart for a process for providing memories based on a process of machine learning 200 is depicted according to at least one embodiment. At 202, the memory provision program 150 collects biometric data about a subject. A subject may be, for example, a user or patient. Biometric data may include, for example, blood pressure, heart rate, respiratory data, eye-tracking data, or any other data providing insight into a subject's physical or mental state. Biometric data may be collected by any sensor, including an ordinary sensor such as a camera or microphone or a dedicated biometric sensor such as a heart rate sensor or blood glucose monitor. Biometric data may be collected regularly, at the request of a user, or in response to any event or incident.

Biometric data may be collected according to opt-in procedures. The memory provision program 150 may collect a large variety of biometric data, or only collect data that is suspected to be relevant, pose minimal privacy risk, or be useful in machine learning. For example, collecting may include filtering data that is determined to cause a risk of overfitting in a process of machine learning due to irrelevance. A subject may be, for example, a user or patient. Alternatively, a subject may be a test subject in a study, or a training subject used to assist in generating data for machine learning purposes.

Biometric data may include, for example, blood pressure, heart rate, respiratory data, eye-tracking data, or any other data providing insight into a subject's physical or mental state. For example, biometric data about a person hiking up a mountain may include blood pressure, blood oxygen, and stress indicators. Biometric data may further include baseline data, such as stress indicators before an event begins, or general data, such as a subject's weight or age.

Biometric data may be collected by any sensor, including an ordinary sensor such as a camera or microphone. For example, a single camera or array of cameras used on a smartphone may collect eye-tracking data. Alternatively, a device's accelerometer, location sensor, and other motion sensors may be used to measure a subject's running speed or approximate running speed.

In another embodiment, a sensor may be a dedicated biometric sensor such as a heart rate sensor, blood pressure monitor, pacemaker, or blood glucose monitor. For example, eye-tracking data may be collected by a dedicated headset and camera array designed for eye-tracking. Alternatively, a sensor may be a dedicated brain-computer interface device that interacts directly with a subject's nervous system.

In yet another embodiment, biometric data may be collected from a service or Application Programming Interface (API), such as a mobile operating system's health services API or a hospital's electronic medical record keeping system.

Collecting data may include collecting other data, such as environmental data, personal data, or metadata. Environmental data may, for example, include weather data, location data, or allergen data, and may be collected through the use of the Global Positioning System (GPS), triangulation, geofencing, location APIs, weather APIs, or any other relevant service. Personal data may include a subject's name or an individualized subject identifier, information describing devices used by the subject, or any other data about the subject not captured as biometric data. Metadata may include any data describing any of the data collected, such as the size of a data field or the date on which a piece of data was captured. Other data may further include any data that may potentially be useful in understanding the physical or mental state of the subject, such as a screen time analysis on a device used by the subject, a stock market analysis and data about the subject's stock portfolio, or the subject's music playlists.

Collecting data may include collecting, combining, and processing any amount of data using any of the above methods. For example, collecting data may include collecting a running speed and elevation change through device motion sensors, alongside height, weight, and age data collected from an electronic medical record keeping system for the subject's hospital, and combining them to calculate an approximate number of calories burned. Collecting data may further involve collecting weather data and utilizing a trained neural network to draw conclusions such as the likelihood the subject suffers from a running injury, an allergic reaction to environmental pollen, or a negative emotional reaction to rainy weather.

Biometric data may be collected regularly, at the request of a user, or in response to any event or incident. A user may include the subject or an administrative user responsible for managing users, machine learning, or any other part of the process for providing memories based on a process of machine learning 200. An event may be, for example, a complex task, a stressful incident, a fond memory, or any other event about which a user might be reminded.

Then, at 204, the memory provision program 150 builds a graph based on the biometric data. A graph may be a weighted or unweighted graph. Each node in the graph may represent a data point or parameter such as a biomarker or other data point. An edge in the graph may represent a relationship between data points. A single event or memory may be represented by a graph, or by a cluster in a greater graph.

In at least one embodiment, a node in the graph may represent a data point or parameter such as a biomarker or other piece of biometric data. For example, each node may represent blood pressure at a particular point in time for one event or memory, an overall average of blood pressure for the event or memory, or a graph of blood pressure over the course of the event or memory.

Alternatively, a node may represent any other data point. As described at 202, other data may include environmental data, personal data, metadata, or any data relevant to the process for providing memories based on a process of machine learning 200.

An edge may represent any relationship between any two nodes, including presence in the same or similar events, a relationship representing the same or similar biomarkers or data types, or a similarity in a mental state, physical state, or underlying meaning associated with the data. An edge weight may, for example, represent a degree of connection, and may be positive or negative, with a higher weight representing either a stronger or weaker connection.

A single event or memory may be represented by a graph, or by a cluster in a greater graph. A cluster may be a series of strongly-connected nodes, connected by many edges or edges with especially low or especially high weights. For example, a graph may connect all nodes from the same event with one edge, and use additional edges to connect especially similar biomarkers between separate events. As a more specific example, a graph may represent a series of experiences, one cluster may represent a subject climbing a mountain, another cluster may represent a subject learning to ride a bike, and each cluster may contain a node charting blood pressure over time, another node charting heart rate over time, and another node for eye tracking data over time. In such an example, the nodes of each cluster may be strongly-connected, i.e., all connected to one another, and each blood pressure node may be connected to all other blood pressure nodes by a weight signifying a degree of similarity between the blood pressure patterns they represent.

A graph may be a weighted or unweighted graph. Weights may be applied to nodes, edges, or both. In a preferred embodiment, a weight for a node may represent the importance of the data represented by the node, the likelihood that the data meaningfully reflects an event or memory, the likelihood that the data will be useful in machine learning, or the likelihood that the data will result in the memory provision program 150 providing a meaningful or useful memory to a user. Alternatively, a weight may represent relevance, a privacy risk, or anything else about a node that may be useful to process for providing memories based on a process of machine learning 200.

Alternatively, if a weight is applied to an edge, the weight may represent a similarity or difference between the nodes connected by the edge, either in terms of the type of data they represent, or the mental states, physical states, emotions, biological factors, environmental factors, stress factors, or other features their data represent.

Nodes and edges may have more than one weight representing more than one factor. A graph may further include additional nodes or edges. For example, if a graph cluster represents one event, a node in each cluster may represent the event overall, and an edge between overall event nodes may connect similar events.

In another embodiment, building a graph may include removing data that is suspected to be irrelevant, pose a significant privacy risk, or be of limited use in machine learning. Alternatively, such nodes may be marked by a low weight, privacy flag to limit access to the nodes, or exclusion tag to exclude the nodes from machine learning.

Then, at 206, the memory provision program 150 trains a machine learning model based on the graph. The machine learning model may be any type of model trained according to any method. Training may include training the model according to additional information, such as information collected at 202 that was not used to build the graph at 204, or feedback collected at 208.

The machine learning model may be any type of model trained according to any method. For example, the memory provision program 150 may train a deep neural network or convolutional neural network on the graph, or may train many different models on many different versions of the graph in order to determine which model is most effective in providing memories at 208 for a particular purpose.

In at least one embodiment, training a model may include fast track model training, wherein data is collected from domain experts in the context of simulated events at 202 to build additional graphs at 204. For example, fast track model learning may include generating biometric data by having an expert mountain climber climb a mountain and collecting data from the expert mountain climber, or throwing a fair and collecting biometric data about attending a fair from a large number of fair attendants; building a graph or adding to an existing graph based on the generated data; and training the model based on this generated data.

Training may include training the model according to additional information, such as information collected at 202 that was not used to build the graph at 204, or feedback collected at 208. Additional information may be weighted or unweighted.

Next, at 208, the memory provision program 150 provides a memory to a subject or other user based on the trained model. Providing a memory may include providing a sensation to trigger a memory, directly reminding a user of a memory, recommending relevant memories to a user, or providing stimulus to direct a user to perform an action according to the memory. Providing a memory may be performed in response to a request for a memory or in response to a biometric input. Providing a memory may be performed using, for example, typical device output, augmented reality, or advanced biometric stimulus, such as wearable navigation stimulus or scent.

A memory may be provided to any user, including the subject from 202, a new patient user, an administrative user, or a healthcare professional. A memory may be provided in response to a request from a user. For example, a user may request a memory from the user's wedding reception. In some embodiments, a memory may be provided to one user at the request of another user. For example, medical professionals may request a comforting memory for an agitated patient.

A memory may alternatively be provided in response to a biometric input. For example, if biometric data, such as that collected at 202, indicates that a user is lost and distraught trying to find their way home, the memory provision program 150 may provide a memory that directs the user home.

In at least one embodiment, providing a memory may include directly reminding a user of a memory. For example, if a user's biometric data indicates that a user is hungry, or involves a similar set of biomarkers to the last time the user had a nice dish of pasta, directly reminding a user of that memory may include providing an audio description of the memory to the user, showing the user a photograph that the user shared to social media at the time, or providing the user a recipe associated with the memory as other data.

Alternatively, providing a memory may include providing a sensation to trigger a memory. For example, if a patient associates the sound of dolphins with a calming, happy memory, triggering that memory may include playing dolphin sounds in a headset the patient is wearing, or a speaker within earshot of the patient. Alternatively, if a user is walking home and needs to turn left to get home, a sensation may be a slight tingle in the user's left pinky finger beckoning the user left.

In yet another embodiment, providing a memory may include recommending relevant memories to a user. For example, if a user is found to be hungry, recommending a relevant memory may include recommending a series of recipes that the trained machine learning model finds would satisfy the user's hunger in an appropriate time frame.

In a further embodiment, providing a memory may include providing stimulus to direct a user to perform an action according to the memory. For example, climbing a mountain may include directing a user through augmented reality to place the user's hand on certain grip points as determined by the machine learning model according to its understanding of eye tracking of mountain climbers.

Providing a memory may be performed using, for example, typical device output, such as audio output or visual output on a display. For example, the memory provision program 150 may play audio using a headset the user is wearing or speakers within earshot of the user. Alternatively, the memory provision program 150 may play a slideshow of photos from a user's wedding on a programmable picture frame. As another alternative, typical device output may include printing from a printer, for example in the context of providing a memory of a recipe.

Providing a memory may further include use of augmented reality. For example, an augmented reality headset may use colored light, circles, and arrows to direct a user to perform a particular task in a particular way.

In another embodiment, providing a memory may include use of dedicated or advanced biometric stimulus, such as wearable navigation stimulus or scent. Wearable navigation stimulus may include, for example, bracelets, rings, or shoes that vibrate differentially to signal that a user should move in a particular direction. Scent-based stimulus may include use of a scent-emitting device that can issue scents that remind a subject of a particular memory.

In yet another embodiment, the memory provision program 150 may build connections between a memory across multiple occasions of providing the memory. For example, a scent device may store five scents, and dedicate one scent to each memory. If the first scent involves vanilla and sandalwood, the memory provision program 150 may issue the first scent whenever the user requests a memory of the user's wedding, allowing the user to more effectively recall each occasion where a user was previously provided the memory of the wedding, building a connection between each occasion in order to assist the user build memory patterns more effectively.

In a further embodiment, the memory provision program 150 may collect feedback from a subject, user, or administrator based on the provided memory. For example, if a healthcare professional requests a happy memory to improve a patient's mood, the patient may select a mood as feedback from a simple touch-screen display showing several faces indicating various moods.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
collecting biometric data from a subject in response to an event;
building a graph based on the collected biometric data;
training a machine learning model based on the built graph; and
providing a memory to a user based on the machine learning model.

2. The method of claim 1, wherein the subject is a domain expert in relation to the event.

3. The method of claim 1, wherein a node on the graph is a biometric data point.

4. The method of claim 3, further comprising:
assigning a weight to the node signifying the importance of the biometric data point in remembering the event.

5. The method of claim 1, wherein providing the memory is performed in response to a biometric input.

6. The method of claim 1, wherein providing a memory is performed by providing a stimulus to trigger the memory.

7. The method of claim 1, wherein the machine learning model is a neural network.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
collecting biometric data from a subject in response to an event;
building a graph based on the collected biometric data;
training a machine learning model based on the built graph; and
providing a memory to a user based on the machine learning model.

9. The computer system of claim 8, wherein the subject is a domain expert in relation to the event.

10. The computer system of claim 8, wherein a node on the graph is a biometric data point.

11. The computer system of claim 10, further comprising:
assigning a weight to the node signifying the importance of the biometric data point in remembering the event.

12. The computer system of claim 11, wherein providing the memory is performed in response to a biometric input.

13. The computer system of claim 8, wherein providing a memory is performed by providing a stimulus to trigger the memory.

14. The computer system of claim 8, wherein the machine learning model is a neural network.

15. A computer program product, the computer program product comprising:
one or more computer-readable tangible storage media and program instructions stored on at least one of the one or more tangible storage media, the program instructions executable by a processor capable of performing a method, the method comprising:
collecting biometric data from a subject in response to an event;
building a graph based on the collected biometric data;
training a machine learning model based on the built graph; and
providing a memory to a user based on the machine learning model.

16. The computer program product of claim 15, wherein the subject is a domain expert in relation to the event.

17. The computer program product of claim 15, wherein a node on the graph is a biometric data point.

18. The computer program product of claim 17, further comprising:
assigning a weight to the node signifying the importance of the biometric data point in remembering the event.

19. The computer program product of claim 18, wherein providing the memory is performed in response to a biometric input.

20. The computer program product of claim 15, wherein providing a memory is performed by providing a stimulus to trigger the memory.
